(19) United States
(12) Patent Application Publication
(10) Pub. No.: US 2011/0275004 A1
(43) Pub. Date: Nov. 10, 2011

(54) FUEL CELL SOCKETS, AND FUEL CELL COUPLERS AND FUEL CELLS USING SAME

(76) Inventors: Kenichi TAKAHASHI, Yokohama-shi (JP); Koichi Kawamura, Yokohama-shi (JP); Hiroyuki Hasebe, Chigasaki-shi (JP); Kenji Yoshihiro, Yokohama-shi (JP); You Yamamori, Yokohama-shi (JP)

(21) Appl. No.: 13/160,274

(22) Filed: Jun. 14, 2011

Related U.S. Application Data
(63) Continuation of application No. PCT/JP2009/006808, filed on Dec. 11, 2009.

(30) Foreign Application Priority Data
Dec. 15, 2008 (JP) P2008-318409

(51) Int. Cl. H01M 8/04; H01M 8/10

(52) U.S. Cl. 429/480; 429/513

(57) ABSTRACT

A fuel cell socket, to which a fuel cell plug for discharging a liquid fuel for a fuel cell is detachably connected, includes a cylindrical socket body having a diameter-reduced part provided at a substantially intermediate position in an axial direction, a valve having a shaft portion which is protruded toward a connection side through the diameter-reduced part, an elastic cylindrical fuel introduction path which is provided to surround the shaft portion protruded from the diameter-reduced part and has a fastener provided at a side portion, and an auxiliary elastic body which is provided outside the fuel introduction path and pushes the fastener toward the connection side.

### CROSS-REFERENCE TO RELATED APPLICATIONS

This application is a continuation of prior International Application No PCT/JP2009/006808, filed on Dec. 11, 2009 which is based upon and claims the benefit of priority from Japanese Patent Application No. 2008-318409, filed on Dec. 15, 2008; the entire contents of all of which are incorporated herein by reference.

### FIELD

Embodiments described herein relate generally to fuel cell socket used to supply a liquid fuel to a fuel cell, and a fuel cell coupler and a fuel cell using the same.

### BACKGROUND

In recent years, attempts have been made to use a fuel cell as a power source for various types of portable electronic equipment such as a notebook computer, a cellular phone and the like to make it possible to use them for a long time without recharging. The fuel cell can generate electricity by merely supplying a fuel and air and can generate continuously for a long time by replenishing the fuel. Therefore, if the fuel cell can be made compact, it is a very advantageous system as a power source for portable electronic equipment.

Especially, a direct methanol fuel cell (DMFC) using a methanol fuel having a high energy density is promising as a power source for portable appliances because it can be made compact and its fuel can also be handled with ease. As a method of supplying the liquid fuel of the DMFC, there are known an active method such as a gas supply type, a liquid supply type or the like and a passive method such as an inside vaporization type which supplies the liquid fuel from a fuel storing portion to a fuel electrode by vaporizing in the fuel cell. The passive method is advantageous for miniaturization of the DMFC.

The passive type DMFC vaporizes the methanol fuel stored in the fuel storing portion via a fuel impregnation layer, a fuel vaporization layer or the like to supply to the fuel electrode. And, the liquid fuel such as the methanol fuel is supplied to the fuel storing portion by means of a satellite type (external injection type) fuel cartridge.

When the fuel cartridge is used to supply the liquid fuel, a coupler for a fuel cell generally comprising a fuel cell socket and a fuel cell plug is used. The fuel cell socket and the fuel cell plug each have a valve mechanism which has a valve as a valve body therein, and the fuel cell plug is connected to the fuel cell socket to contact their valves to bring the valve mechanisms into an open state.

Therefore, the liquid fuel stored in the fuel cartridge can be supplied to the fuel cell, specifically into the fuel storing portion by, for example, attaching the fuel cell socket to the fuel cell, attaching the fuel cell plug to the fuel cartridge and inserting the fuel cell plug into the fuel cell socket. And, the fuel cell plug is pulled out from the fuel cell socket to separate their valves to bring the valve mechanisms into a closed state, and the liquid fuel supply can be stopped.

As such a fuel cell socket, it is known that, for example, a valve is arranged in a cylindrical socket body and an elastic cylindrical fuel introduction path, which is called a rubber holder or the like, is disposed to cover the periphery of the valve connection side. When the fuel cell plug is connected, the fuel introduction path is contacted to the periphery of a discharge port which discharges the liquid fuel and becomes a passage for guiding the discharged liquid fuel into the fuel cell socket. As such a fuel introduction path, there is a known path, which has, for example, a bellows-like shape to be stretchable axially.

But, the property of the above fuel introduction path is degraded when it is used for a long period and there is a possibility that the repulsion force becomes weak and the fuel introduction path which is once shrunk does not return to the original state. When the fuel cell plug is connected to the fuel introduction path of which property is degraded, the contact to the periphery of the discharge port cannot be made properly, and the liquid fuel might leak to the outside.

### BRIEF DESCRIPTION OF THE DRAWINGS

FIG. 1 is a schematic view showing an application method of a fuel cell socket according to an embodiment.

FIG. 2 is a sectional view showing a fuel cell socket according to a first embodiment.

FIG. 3 is a sectional view showing an example of a fuel cell plug to be connected to the fuel cell socket shown in FIG. 2.

FIG. 4 is a sectional view showing a state that the fuel cell plug is connected to the fuel cell socket shown in FIG. 2.

FIG. 5 is a sectional view showing a fuel cell socket according to a second embodiment.

FIG. 6 is a sectional view showing a state that the fuel cell plug is connected to the fuel cell socket shown in FIG. 5.

FIG. 7 is a sectional view showing a fuel cell socket according to a third embodiment.

FIG. 8 is a sectional view showing a state that the fuel cell plug is connected to the fuel cell socket shown in FIG. 7.

FIG. 9 is a sectional view showing a fuel cell according to an embodiment.

### DETAILED DESCRIPTION

In one embodiment, a fuel cell socket is detachably connected to a fuel cell plug for discharging a liquid fuel for a fuel cell. The fuel cell socket includes a cylindrical socket body having a diameter-reduced part provided at a substantially intermediate position in an axial direction, a valve having a shaft portion which is protruded toward a connection side with the fuel cell plug through the diameter-reduced part, an elastic cylindrical fuel introduction path which is provided to surround the shaft portion protruded from the diameter-reduced part and has a fastener provided at a side portion, and an auxiliary elastic body which is provided outside the fuel introduction path and pushes the fastener toward the connection side.

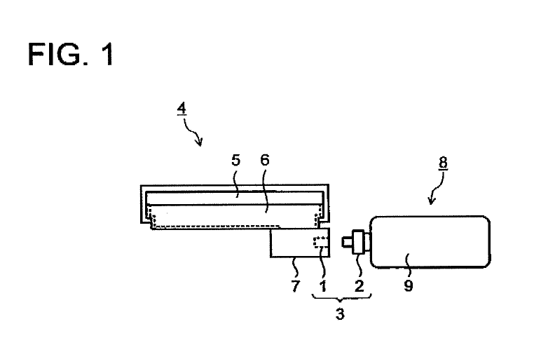

Embodiments will be described with reference to the drawings. FIG. 1 is a schematic view showing an application method of a fuel cell socket 1 (hereinafter, simply called as a socket 1) of an embodiment. The fuel cell socket 1 is detachably connected to a fuel cell plug 2 (hereinafter, simply called as a plug 2) to configure a fuel cell coupler 3 (hereinafter, simply called as a coupler 3).

The socket 1 and the plug 2 each have a valve which configures a valve mechanism, and in the separated state as shown in the drawing, their valve mechanisms are closed to suppress the liquid fuel from outflowing. And, when the plug 2 is connected to the socket 1, their valves are mutually contacted to open the valve mechanisms, enabling to supply the liquid fuel.

The socket 1 is used by being attached to a fuel cell 4. The fuel cell 4 has a fuel battery cell 5 which becomes, for example, an electromotive portion, a fuel storing portion 6 which stores the liquid fuel to be supplied to the fuel battery cell 5, and a fuel receiving portion 7 which is attached to the fuel storing portion 6 and supplies the liquid fuel. The socket 1 is attached to, for example, the fuel receiving portion 7.

Meanwhile, the plug 2 is attached to a cartridge 8 when it is used. The cartridge 8 has a cartridge body 9 which is a container for storing the liquid fuel and has the plug 2 for discharging the liquid fuel attached to its leading end. This cartridge 8 is a so-called satellite type (external injection type) cartridge and connected only when the liquid fuel is injected into to the fuel cell 4.

The cartridge body 9 stores a liquid fuel suitable for the fuel cell 4, for example, a methanol fuel such as an aqueous methanol solution having a variable concentration, pure methanol or the like for a direct methanol fuel cell (DMFC). The liquid fuel stored in the cartridge body 9 is not necessarily limited to the methanol fuel but may be another liquid fuel, for example, an ethanol fuel such as an aqueous ethanol solution or pure ethanol, a propanol fuel such as an aqueous propanol solution or pure propanol, a glycol fuel such as an aqueous glycol solution or pure glycol, dimethyl ether or formic acid. At any event, a liquid fuel suitable for the fuel cell 4 is stored.

The socket 1 is described below specifically. In the drawings showing the socket 1, the top side is a side to which the plug 2 is connected. It is determined in the following description that the side (top side in the drawings) of the socket 1 to which the plug 2 is connected is called a connection side, and the opposite side (bottom side in the drawings) is called a bottom side.

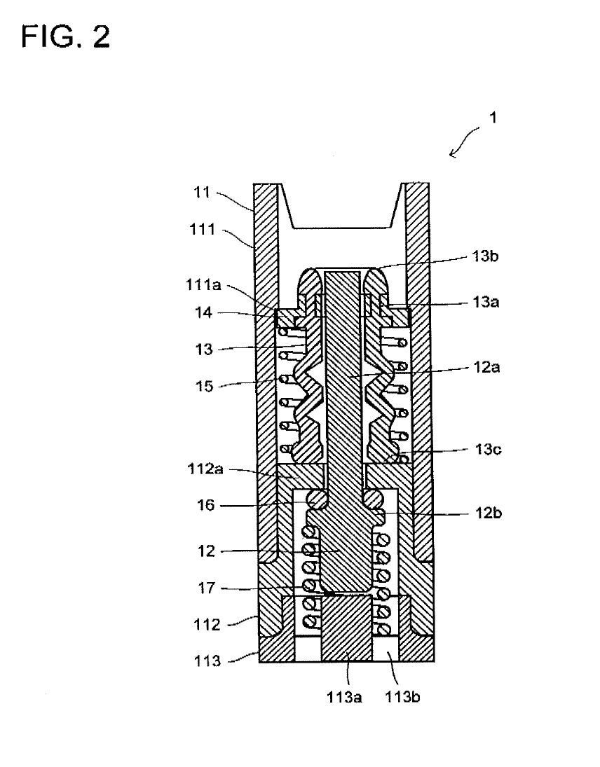

FIG. 2 is a sectional view showing the socket 1 of a first embodiment. FIG. 2 shows a state that the valve mechanism is closed. The socket 1 is also called a female coupler and mainly configured of a cylindrical socket body 11, a valve 12 disposed within the socket body 11, a fuel introduction path 13 disposed around the side wall of the connection side of the valve 12, a fastener 14 disposed on the fuel introduction path 13, and an auxiliary elastic body 15 for pushing the fastener 14. The socket body 11 is configured of a first cylinder portion 111 having a substantially cylindrical shape disposed, for example, on the connection side, a second cylinder portion 112 which is fixed by being fitted into the bottom side of the first cylinder portion 111, and a third cylinder portion 113 which is fixed by being fitted into the bottom side of the second cylinder portion 112.

The first cylinder portion 111 is formed to have a stepped portion by, for example, making an inner diameter of the connection side smaller than that of the bottom side to form a positioning portion 111a which limits the movement of the fastener 14 to the connection side by the stepped portion and specifies an initial positional state. The second cylinder portion 112 has a diameter-reduced part 112a on the connection side, the inner diameter of the diameter-reduced part 112a is determined so that the connection side of the valve 12 can be inserted, and the liquid fuel can be passed through it.

The third cylinder portion 113 has a valve contact portion 113a, which limits the movement of the valve 12 toward the bottom side, formed on a shaft center part. Plural flowing holes 113b, which become passages for the liquid fuel, are formed around the valve contact portion 113a with at equal intervals.

The valve 12 mainly configures the valve mechanism in combination with the socket body 11 and has a shaft portion 12a which is protruded toward the connection side through the diameter-reduced part 112a, and a head portion 12b which is disposed on the bottom side of the diameter-reduced part 112a. An annular sealing member 16 such as an O-ring is arranged on the connection side of the head section 12b, and a valve elastic body 17 such as a compression spring is disposed on the bottom side. The annular sealing member 16 is pushed by the valve elastic body 17 via the head section 12b to close the diameter-reduced part 112a, so that the liquid fuel is suppressed from leaking to the connection side.

The fuel introduction path 13 is formed of an elastic material to have a cylindrical shape and its interior becomes a path for the liquid fuel discharged from the plug 2. The fuel introduction path 13 as substantially the whole has a bellows shape excluding some portions of the connection side, namely the end of the connection side and a mounting portion 13a to which the fastener 14 is attached, so that it is axially stretchable by virtue of the bellows shape and the material property (rubber elasticity).

For example, the mounting portion 13a is formed as a groove around the side surface of the fuel introduction path 13. And, both ends of the fuel introduction path 13 are determined as a sealing portion 13b and a sealing portion 13c, and, for example, they are determined to have a cross section protruded axially. That is, the sealing portion 13b at the end of the connection side provides a sealed state by contacting to the periphery of the discharge port for discharging the liquid fuel of the plug 2 and has a shape protruded toward the plug 2. Meanwhile, the sealing portion 13c at the end on the bottom side comes into contact with the diameter-reduced part 112a to provide a sealed state and has a shape protruded toward the diameter-reduced part 112a.

The fuel introduction path 13 is disposed to surround the whole portion of the shaft portion 12a which is a portion protruded toward the connection side from the diameter-reduced part 112a. The connection-side end of the fuel introduction path 13 is extended toward the connection side to be slightly longer than the shaft portion 12a to protect, for example, the connection-side end of the shaft portion 12a and to contact to the periphery of the discharge port for discharging the liquid fuel of the plug 2, before the shaft portion 12a is inserted into it, to provide a sealed state.

The fastener 14 and the auxiliary elastic body 15 are disposed to push the connection-side end of the fuel introduction path 13 toward the tip end side. The fastener 14 is attached to the side portion of the fuel introduction path 13, and the auxiliary elastic body 15 is disposed at the bottom side of the fastener 14 and the outside of the fuel introduction path 13 to push the fastener 14 toward the connection side.

By disposing the fastener 14 and the auxiliary elastic body 15 as described above, the connection-side end of the fuel introduction path 13 can be appropriately contacted to the periphery of the discharge port for discharging the liquid fuel to provide a sealed state when the plug 2 is connected. Thus, the liquid fuel is suppressed from leaking to the outside, and it can be made excellent in safety. Especially, if the property of the fuel introduction path 13 is degraded when it is used for a long period, the liquid fuel is effectively suppressed from leaking to the outside. Thus, excellent safety can be provided.

Even when the auxiliary elastic body 15 is disposed as described above, mixing of metal ions, which elute from the auxiliary elastic body, into the liquid fuel can be suppressed by the auxiliary elastic body 15 disposed outside of the fuel introduction path 13, and the power generation characteristic of the fuel cell can also be suppressed from degrading.

The fastener 14 is suppressed from moving to the tip end side by the positioning portion 111a disposed in the socket body 11 (first cylinder portion 111) and from coming out of the socket body 11, and held in the initially positioned state. And, since the initially positioned state of the fastener 14 is maintained as described above, the initially positioned state at the connection-side end of the fuel introduction path 13 can also be maintained.

The fastener 14 is, for example, an annular member having a retaining hole to retain the fuel introduction path 13 and fitted by externally fitting into the mounting portion 13a which is disposed on the connection-side end of the fuel introduction path 13. The position where the fastener 14 is attached is not necessarily the connection-side end of the fuel introduction path 13, but preferably the connection-side end of the fuel introduction path 13 from the viewpoint that the connection-side end of the fuel introduction path 13 is pushed toward the connection side to appropriately contact to the periphery of the discharge port for discharging the liquid fuel of the plug 2.

It is preferable that the outside diameter of the fastener 14 is similar to the inside diameter of the socket body 11 such that the fastener 14 can slide inside the socket body 11 (first cylinder portion 111). By determining as described above, the shaft center of the socket body 11 and that of the fuel introduction path 13 are aligned, and the connection-side end of the fuel introduction path 13 can be contacted more securely to the periphery of the discharge port for discharging the liquid fuel of the plug 2 to provide the sealed state.

The fuel introduction path 13 and the annular sealing member 16 are preferably made of ethylene-propylene-diene rubber (EPDM) having resistance to the liquid fuel, and especially methanol resistance. But, the EPDM is not exclusively used, and they may also be made of silicone rubber (VMQ), fluorosilicone rubber (EVMQ), fluororubber (FKM), nitrile rubber (NBR), or hydrogenated nitrile rubber (HNBR).

The auxiliary elastic body 15 is not necessarily contacted to the liquid fuel but preferably undergone a surface treatment in case it contacts with the liquid fuel. Meanwhile, the valve elastic body 17 is preferably undergone the surface treatment because it is disposed in the path of the liquid fuel. Specifically, for such an elastic body, it is preferable to use a stainless steel-based spring whose corrosion resistance is enhanced by a passivation treatment. For the surface treatment, not only the passivation treatment, but also precious metal plating of gold or the like or resin coating of fluorine-based resin or the like can also be used suitably. And, a spring using carbon as a material can also be used.

It is preferable that other members are generally made of a non-metallic material, and they are preferably made of a resin material having resistance to the liquid fuel, and particularly methanol resistance. Examples of such resin materials include polypropylene (PP), polyphenylene sulfide (PPS), high-density polyethylene (HDPE), polystyrene (PS), polyether ether ketone (PEEK: trade name, Victrex plc), liquid crystal polymer (LCP), polybutylene terephthalate (PBT), polyacetal (POM) and the like. Examples of the resin materials having methanol resistance and transparency include polyethylene naphthalate (PEN), polyethylene terephthalate (PET), cyclic olefin copolymer (COC), cyclo-olefin polymer (COP), polymethylpentene (TPX), polyphenylsulfone (PPSU), polyethersulphone (PES) and the like.

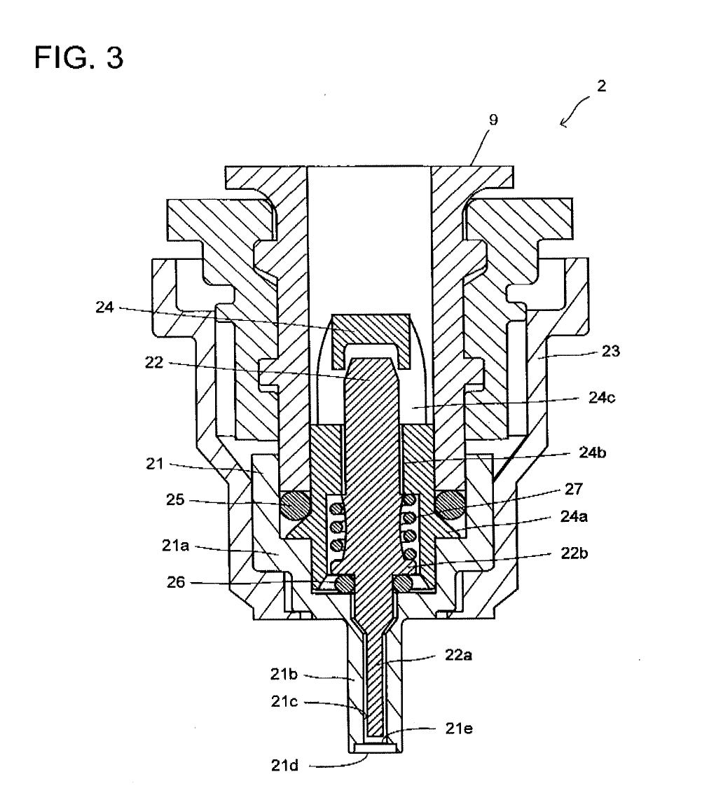

FIG. 3 shows the plug 2 to be connected to the socket 1. In the drawings showing the plug 2, the bottom side is a side which is connected to the socket 1. It is determined in the following description that the side (bottom side in the drawing) of the plug 2, which is connected to the socket 1, is called a connection side, and its opposite side (top side in the drawing) is called a bottom side.

The plug 2 is also called a male-side coupler and has a plug head 21 in which the cartridge body 9 is fitted, a valve 22 to be disposed within the plug head 21, a holding cap 23 which externally covers the plug head 21 to fix it to the cartridge body 9, and the like.

The plug head 21 has a cylindrical base section 21a, in which the cartridge body 9 is fitted, and an insertion portion 21b which is disposed on its connection side and has a smaller diameter. A shaft hole 210 which becomes a path for the liquid fuel stored in the cartridge body 9 and in which the valve 22 is movably inserted is formed in the shaft center part of the insertion portion 21b. A sealing recessed portion 21d, in which the fuel introduction path 13 is fitted, is formed at an end of the insertion portion 21b, and a discharge port 21e which is connected to the shaft hole 21c is formed in the bottom of the sealing recessed portion 21d.

The discharge port 21e is a part to discharge the liquid fuel which is stored in the cartridge body 9, and the sealing recessed portion 21d functions as a temporary storing portion for the remaining (adhered matter) of the liquid fuel discharged from the discharge port 21e, such that an operator is prevented from touching the liquid fuel. In the connected state, the tip end of the fuel introduction path 13 is fitted into the sealing recessed portion 21d, so that the periphery of the discharge port 21e is sealed, and the liquid fuel is suppressed from outflowing to the outside.

A valve holder 24 which holds the valve 22 is disposed within the base section 21a. The valve holder 24 defines a valve chamber, and a flange portion 24a which is formed on the outer edge portion of the connection side is fixed to the base section 21a by being pushed by the cartridge body 9 from the bottom side through an annular sealing member 25 such as an O-ring. And, a shaft hole 24b in which the valve 22 is movably inserted is formed at an almost intermediate position of the valve holder 24, and a communication hole 24c which becomes a path for the liquid fuel from the cartridge body 9 is formed in the rear end portion.

The valve 22 mainly configures a valve mechanism in combination with the plug head 21 and has a shaft portion 22a to be inserted into a shaft hole 21c, and a head section 22b which is disposed on the bottom side of the shaft hole 21e. An annular sealing member 26 such as an O-ring is arranged on the tip end side of the head section 22b to surround the periphery of the shaft portion 22a, and a valve elastic body 27 such as a compression spring is disposed on the bottom side of the head section 22b to push the valve 22 toward the tip end side. And the annular sealing member 26 is pushed by the valve elastic body 27 via the head section 22b to close the shaft hole 21c to suppress the liquid fuel from leaking.

The annular sealing member 26 and the annular sealing member 27 are preferably made of ethylene-propylene-diene rubber (EPDM) having resistance to the liquid fuel, and especially methanol resistance. But, the EPDM is not exclusively used, but they may be made of silicone rubber (VMQ), fluorosilicone rubber (FVMQ), fluororubber (FKM), nitrile rubber (NSR), or hydrogenated nitrile rubber (HNBR).

The valve elastic body 27 is preferably undergone the surface treatment because it is disposed in the path of the liquid fuel. Specifically, for such an elastic body, it is preferable to use a stainless steel-based spring which is undergone a passivation treatment to enhance corrosion resistance. For the surface treatment, not only the passivation treatment, but also precious metal plating of gold or the like or resin coating of fluorine-based resin or the like can be used suitably. And, a spring using carbon as a material can also be used.

It is preferable that other members of the plug 2 are generally made of a non-metallic material, and they are preferably made of a resin material having resistance to the liquid fuel, and particularly methanol resistance. Examples of such resin materials include polypropylene (PP), polyphenylene sulfide (PPS), high-density polyethylene (HOPE), polystyrene (PS), polyether ether ketone (PEEK: trade name, Victrex plc), liquid crystal polymer (LCP), polybutylene terephthalate (PBT), polyacetal (POM) and the like. Examples of the resin materials having methanol resistance and transparency include polyethylene naphthalate (PEN), polyethylene terephthalate (PET), cyclic olefin copolymer (COC), cyclo-olefin polymer (COP), polymethylpentene (TPX), polyphenylsulfone (PPSU), polyethersulphone (PES) and the like.

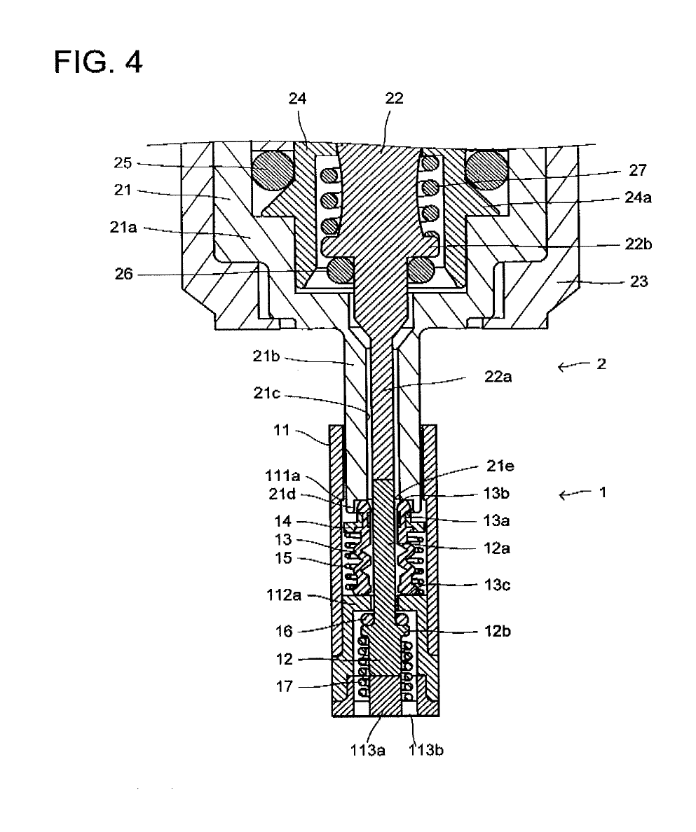

FIG. 4 is a sectional view showing a state that the socket 1 and the plug 2 are mutually connected. The socket 1 and the plug 2 are connected as follows.

First, when the insertion portion 21b of the plug 2 is inserted into the socket body 11, the connection-side end (sealing portion 13b) of the fuel introduction path 13 is fitted into the sealing recessed portion 21d of the insertion portion 21b and contacted to the periphery of the discharge port 21e formed in its bottom to provide a sealed state.

When the plug 2 is further inserted, the fuel introduction path 13 is shrunk by being pushed downward by the plug 2 and the fastener 14 is also moved toward the bottom side in accordance with the shrinkage of the fuel introduction path 13. Since the position of the socket-side valve 12 does not change, it is inserted into the discharge port 21e of the plug 2 and contacted to the plug-side valve 22.

When the plug 2 is inserted with the socket-side valve 12 and the plug-side valve 22 in a mutually contacted state, the socket-side valve 12 is pushed down by the plug-side valve 22 to move to the bottom side, and the valve mechanism of the socket 1 is opened.

An order of opening both the valve mechanisms is determined by adjusting the repulsion force of the valve elastic bodies which push the valves. In this case, the repulsion force of the valve elastic body 27, which pushes the plug-side valve 22, is set to be larger than that of the valve elastic body 17 which pushes the socket-side valve 12, so that the valve mechanism of the socket 1 is configured to open earlier than that of the plug 2. Safety can be secured easily by opening the valve mechanism of the socket 1 to be supplied with the liquid fuel earlier, but the order of opening the valve mechanisms is not necessarily limited to the above.

When the plug 2 is further inserted, the socket-side valve 12 is contacted to the valve contact portion 113a which is disposed on the bottom side. When the socket-side valve 12 is in a state contacted to the valve contact portion 113a and the plug 2 is further inserted, the plug-side valve 22 is moved to the bottom side by being pushed back by the socket-side valve 12, and the valve mechanism of the plug 2 is opened.

When the valve mechanism of the plug 2 is opened, the liquid fuel stored in the cartridge body 9 is discharged from the discharge port 21e through the shaft hole 21c. And, the liquid fuel discharged from the discharge port 21e flows sequentially through the fuel introduction path 13 and the diameter-reduced part 112a and finally supplied form the flowing holes 113b to the fuel cell 4 through the fuel receiving portion 7. The connection of the socket 1 and the plug 2 is completed when the plug-side valve 22 is contacted to the rear end portion of the valve holder 24 and it becomes hard to further insert the plug 2 (FIG. 4).

To remove the plug 2 from the socket 1, the above-described procedure is performed reversely. First, when the plug 2 is pulled out from the socket 1, only the insertion portion 21b is pulled out without changing the position of the plug-side valve 22 viewed from the socket 1; and the valve mechanism of the plug 2 is closed as a result.

When the valve mechanism of the plug 2 is closed, the valve 22 is also pulled out together with the insertion portion 21b of the plug 2, the socket-side valve 12 is moved toward the connection side, and the valve mechanism of the socket 1 is closed as a result.

When the plug 2 is further pulled from the socket 1, the socket-side valve 12 and the plug-side valve 22 are separated from each other, and then the connection-side end of the fuel introduction path 13 is separated from the periphery of the discharge port 21e of the plug 2 to release the sealed state. According to the socket 1 of the embodiment, the fastener 14 and the auxiliary elastic body 15 are disposed in addition to the fuel introduction path 13, so that the connection-side end of the fuel introduction path 13 can be kept contacted to the periphery of the discharge port 21e of the plug 2 during the series of process of connecting and removing the plug 2, and the liquid fuel is suppressed from leaking to the outside. Thus, excellent safety can be provided.

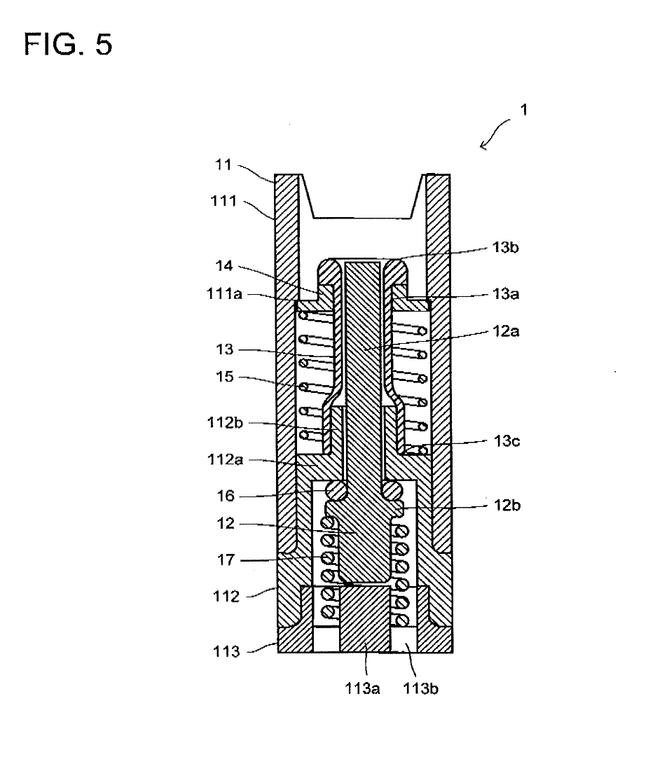

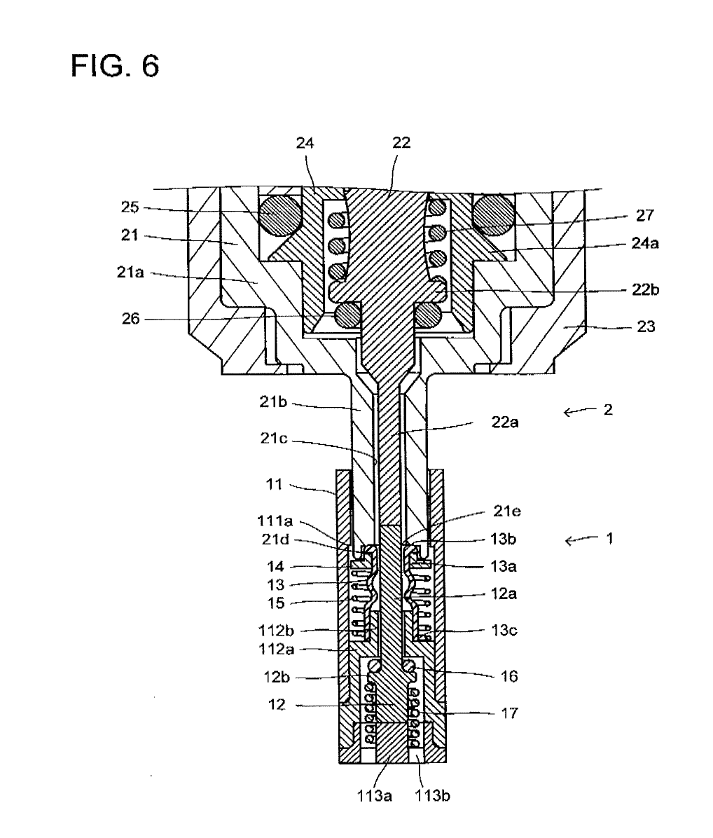

A socket 1 according to a second embodiment is described below. FIG. 5 is a sectional view showing the socket 1 of the second embodiment. FIG. 6 is a sectional view showing a state that a plug 2 is connected to the socket 1. The plug 2 can be made similar to the socket 1 of the first embodiment.

The socket 1 has an inner cylinder portion 112b, which extends from the diameter-reduced part 112a toward the connection side as shown in FIG. 5, and the bottom-side end of the fuel introduction path 13 is expanded to attach to the inner cylinder portion 112b to cover the whole of it. The fuel introduction path 13 in a state not attached to the socket body 11 has a predetermined size that substantially the whole excluding the connection-side end is slightly larger than the shaft portion 12a.

As shown in FIG. 6, the fuel introduction path 13 shrinks by axially deforming a substantially intermediate portion to bow outward. And, at the time of connecting the plug 2, the fuel introduction path 13 is axially pushed by the insertion portion 21b and the diameter-reduced part 112a, so that the sealing portion 13b which is a connection-side end is contacted to the periphery of the discharge port 21e to provide a sealed state, and the sealing portion 13c which is a bottom-side end is contacted to the diameter-reduced part 112a to provide a sealed state.

At the bottom side of the fuel introduction path 13, the sealing portion 13c which is an end portion and the diameter-reduced part 112a are mainly contacted to provide a sealed state, but since the inner surface of the fuel introduction path 13 and the outer surface of the inner cylinder portion 112b are also contacted, they additionally provide a sealed state.

Thus, when the bottom-side end of the fuel introduction path 13 is contacted to the diameter-reduced part 112a and its inner surface is contacted to the outer surface of the inner cylinder portion 112b, it is preferable that the connected part of the diameter-reduced part 112a and the inner cylinder portion 112b is caused to reduce gradually its diameter toward the connection side according to the shape of the sealing portion 13c to secure the sealed state.

The above socket 1 can also be used with the plug 2 connected in the same manner as the socket 1 of the first embodiment. And, the fastener 14 and the auxiliary elastic body 15 are disposed, so that when the plug 2 is connected, the connection-side end of the fuel introduction path 13 can be appropriately contacted to the periphery of the discharge port 21e to provide a sealed state, and the liquid fuel is suppressed from leaking to the outside. Thus, excellent safety can be provided. And, when the auxiliary elastic body 15 is disposed outside of the fuel introduction path 13, metal ions and the like which elute from the auxiliary elastic body can be suppressed from mixing into the liquid fuel, and the power generation characteristic of the fuel cell 4 can also be suppressed from degrading.

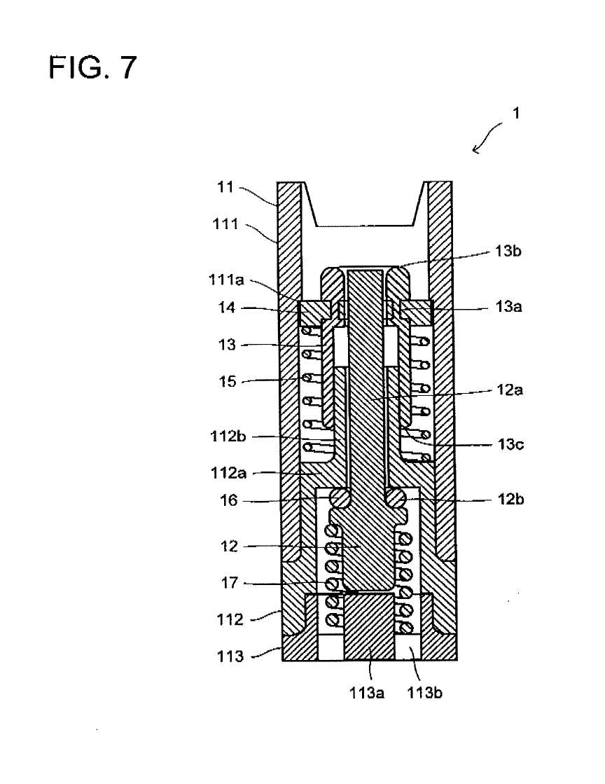

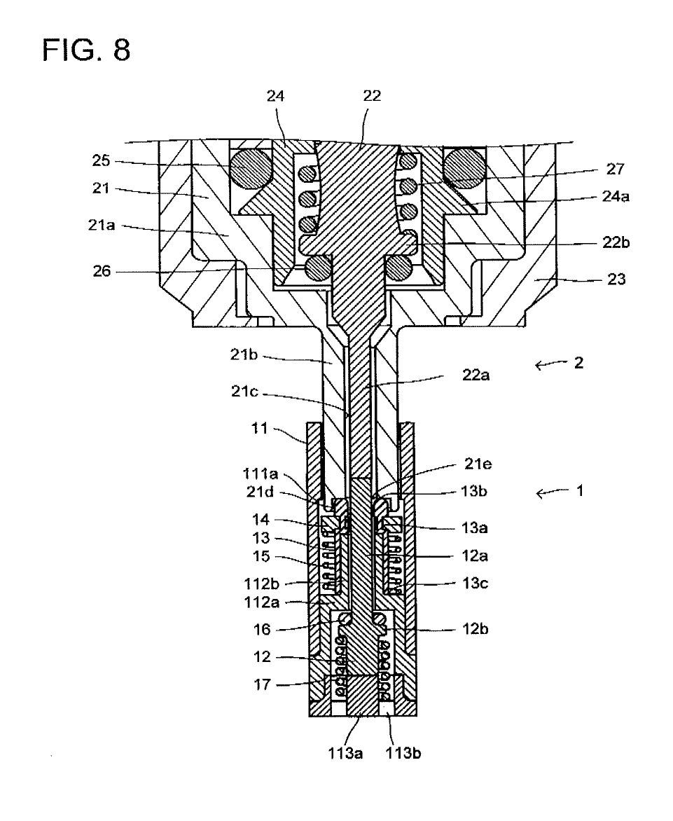

A socket 1 according to a third embodiment is described below. FIG. 7 is a sectional view showing the socket 1 of the third embodiment. FIG. 8 is a sectional view showing a state that the plug 2 is connected to the socket 1. The plug 2 can be made similar to that of the socket 1 of the first embodiment.

As shown in FIG. 7, the socket 1 has an inner cylinder portion 112b which extends from the diameter-reduced part 112a toward the connection side, and a fuel introduction path 13 used covers slidably a part of the connection side of the inner cylinder portion 112b. Specifically, the fuel introduction path 13 used is determined that its inside diameter on the bottom side is different from the mounting portion 13a and substantially same as the outside diameter of the inner cylinder portion 112b in a range slidable along the inner cylinder portion 112b.

When the plug 2 is inserted as shown in, for example, FIG. 8, the fuel introduction path 13 slides to the bottom side and is pushed axially by the insertion portion 21b and the diameter-reduced part 112a, the sealing portion 13b of the connection-side end is contacted to the periphery of the discharge port 21e to provide a sealed state, and the sealing portion 13c which is a bottom-side end is contacted to the diameter-reduced part 112a to provide a sealed state.

The bottom side of the fuel introduction path 13 is brought into a sealed state when the fuel introduction path 13 is moved to the bottom side to contact the sealing portion 13c at the end and the diameter-reduced part 112a. But in a case other than the above, the inner surface of the fuel introduction path 13 and the outer surface of the inner cylinder portion 112b are mutually contacted to provide a sealed state.

To make the sealed state of the above case secure, it is preferable to reduce gradually the diameter of the connected portion of the diameter-reduced part 112a and the inner cylinder portion 112b toward the connection side according to the shape of the sealing portion 13c.

The above socket 1 can also be used with the plug 2 connected in the same manner as the socket 1 of the first embodiment. And, by provision of the fastener 14 and the auxiliary elastic body 15, the connection-side end of the fuel introduction path 13 can be appropriately contacted to the periphery of the discharge port 21e to provide a sealed state when the plug 2 is connected, and the liquid fuel is suppressed from leaking to the outside. Thus, excellent safety can be provided. And, when the auxiliary elastic body 15 is disposed outside of the fuel introduction path 13, mixing of metal ions and the like, which elute from the auxiliary elastic body, into the liquid fuel can be suppressed, and the power generation characteristic of the fuel cell 4 can also be suppressed from degrading.

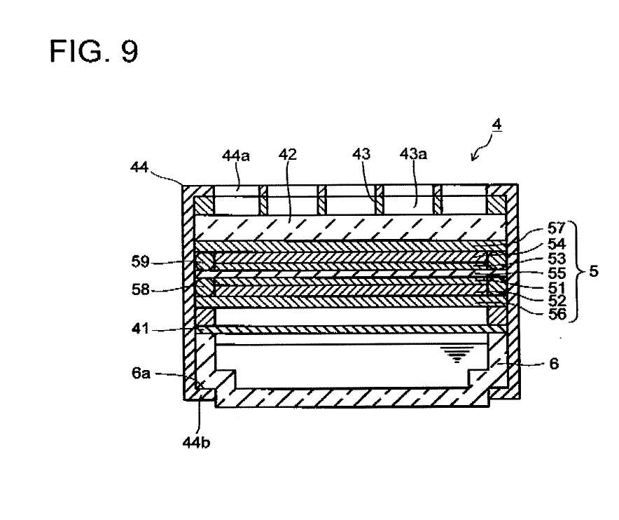

The fuel cell 4 according to the embodiment is described below with reference to an inside vaporization type DMFC. FIG. 9 is a sectional view showing an example of the fuel cell 4. The fuel cell 4 is mainly comprised of a fuel battery cell 5 which configures an electromotive portion, a fuel storing portion 6, and an unshown fuel receiving portion 7 having a socket 1. The unshown fuel receiving portion 7 is disposed on the bottom surface of the fuel storing portion 6 as shown in FIG. 1.

The fuel battery cell 5 has a membrane electrode assembly (MEA) which is composed of an anode (fuel electrode) comprising an anode catalyst layer 51 and an anode gas diffusion layer 52, a cathode (oxidant electrode/air electrode) comprising a cathode catalyst layer 53 and a cathode gas diffusion layer 54, and a proton (hydrogen ion) conductive electrolyte membrane 55 sandwiched between the anode catalyst layer 51 and the cathode catalyst layer 53.

Examples of the catalyst contained in the anode catalyst layer 51 and the cathode catalyst layer 53 include a single element of platinum group elements such as Pt, Ru, Rh, Ir, Os, Pd, etc., an alloy containing a platinum group element, and the like. Specifically, it is preferable to use Pt—Ru, Pt-MO or the like which has high resistance to methanol and carbon monoxide for the anode catalyst layer 51, and it is preferable to use platinum, Pt—Ni or the like for the cathode catalyst layer 53. And, a supported catalyst using a conductive carrier such as carbon material or an unsupported catalyst may be used.

Examples of the proton conductive material configuring the electrolyte membrane 55 include a fluorine-based resin (Nafion (trade name, a product of DuPont), Flemion (trade name, a product of Asahi Glass Co., Ltd.) and the like) such as a perfluorosulfonic acid polymer having a sulfonic group, a hydrocarbon-based resin having the sulfonic group, an inorganic substance such as tungstic acid or phosphotungstic acid, and the like. But, they are not used exclusively.

The anode gas diffusion layer 52 laminated on the anode catalyst layer 51 serves to uniformly supply the fuel to the anode catalyst layer 51 and also serves as a power collector of the anode catalyst layer 51. Meanwhile, the cathode gas diffusion layer 54 laminated on the cathode catalyst layer 53 serves to uniformly supply an oxidant to the cathode catalyst layer 53 and also serves as a power collector of the cathode catalyst layer 53. An anode conductive layer 56 is laminated on the anode gas diffusion layer 52, and a cathode conductive layer 57 is laminated on the cathode gas diffusion layer 54.

For the anode conductive layer 56 and the cathode conductive layer 57, there is used, for example, a porous layer of a mesh form, a thin film or a foil, which is formed of a conductive metal material such as Au or Ni or a composite material having a conductive metallic material such as stainless steel (SUS) coated with a good conductive metal such as Au. Annular sealing members 58 and 59 such as rubber O-rings are interposed between the electrolyte membrane 55 and the anode conductive layer 56 and between the electrolyte membrane 55 and the cathode conductive layer 57, respectively. They prevent the fuel and the oxidant from leaking from the fuel battery cell 5

For example, a methanol fuel is charged as liquid fuel in the fuel storing portion 6. The fuel storing portion 6 is open on the side of the fuel battery cell 5, and the selective gas permeable membrane 41 is disposed between the opening portion of the fuel storing portion 6 and the fuel battery cell 5. The selective gas permeable membrane 41 is a vapor-liquid separating film which allows the passage of only the vaporization component of the liquid fuel but does not allow the passage of the liquid component. The component materials of the selective gas permeable membrane 41 include, for example, a fluorine resin such as polytetrafluoroethylene. The vaporization component of the liquid fuel means a gas mixture, which consists of a vaporization component of methanol and a vaporization component of water when the aqueous methanol solution is used as the liquid fuel, and means a vaporized component of methanol when pure methanol is used.

A moisture retaining layer 42 is laminated on the cathode conductive layer 57, and a surface layer 43 is laminated on the moisture retaining layer 42. The surface layer 43 has a function to adjust an introduced volume of air which is an oxidant, and its adjustment is performed by changing the quantity, size and the like of air introduction ports 43a formed in the surface layer 43. The moisture retaining layer 42 plays a role of suppressing water evaporation by partial impregnation of water generated by the cathode catalyst layer 53 and also has a function to promote uniform diffusion of the oxidant to the cathode catalyst layer 53 by uniform introduction of the oxidant into the cathode gas diffusion layer 54. For example, the moisture retaining layer 42 is formed of a member having a porous structure, and its specific component materials include a porous body or the like of polyethylene or polypropylene.

The selective gas permeable membrane 41, the fuel battery cell 5, the moisture retaining layer 42 and the surface layer 43 which are laminated on the fuel storing portion 6 are held by being covered by, for example, a stainless steel cover 44. The cover 44 is provided with openings 44a at portions corresponding to the air introduction ports 43a which are formed in the surface layer 43. The fuel storing portion 6 is provided with a terrace 6a for receiving a fixture portion 44b of the cover 44, and the terrace 6a is caught by caulking the fixture portion 44b to entirely hold by the cover 44.

In the fuel cell 4 having the structure described above, the liquid fuel (e.g., the aqueous methanol solution) in the fuel storing portion 6 is vaporized, and the vaporized component is supplied to the fuel battery cell 5 through the selective gas permeable membrane 41. In the fuel battery cell 5, the vaporized component of the liquid fuel is diffused by the anode gas diffusion layer 52 and supplied to the anode catalyst layer 51. The vaporised component supplied to the anode catalyst layer 51 causes an internal reforming reaction of methanol expressed by, for example, the following formula (1).

CH₃OH+H₂O→CO₂+H⁺+6e⁻ (1)

When pure methanol is used as the liquid fuel, steam is not supplied from the fuel storing portion 6, so that water produced by the cathode catalyst layer 53 and water in the electrolyte membrane 55 are reacted with the methanol to cause the internal reforming reaction expressed by the formula (1), or an internal reforming reaction is caused by another reaction mechanism not requiring water without depending on the above-described internal reforming reaction of the formula (1).

Proton (H⁺) produced by the internal reforming reaction reaches the cathode catalyst layer 53 through the electrolyte membrane 55. Air (oxidant) introduced through the air introduction ports 43a of the surface layer 43 is diffused in the moisture retaining layer 42, the cathode conductive layer 57 and the cathode gas diffusion layer 54 and supplied to the cathode catalyst layer 53. The air supplied to the cathode catalyst layer 53 causes the reaction expressed by the following formula (2). This reaction causes a power generation reaction involving the generation of water.

(3/2)O₂+6H⁺+6e⁻→3H₂O (2)

with the progress of the power generation reaction based on the above-described reaction, the liquid fuel (e.g., an aqueous methanol solution or pure methanol) in the fuel storing portion 6 is consumed. Since the power generation reaction stops when the liquid fuel in the fuel storing portion 6 is completely consumed, the liquid fuel is supplied from the cartridge 8 into the fuel storing portion 6 at that time or before that.

The supply of the liquid fuel from the cartridge 8 can be performed by connecting the plug 2 attached to the cartridge 8 to the socket 1 attached to the fuel cell 4 as described above. Since the fastener 14 and the auxiliary elastic body 15 are provided to the socket 1 in addition to the fuel introduction path 13, the liquid fuel is suppressed from leaking when connecting. Thus, excellent safety can be provided.

The fuel cell socket of the embodiments, and the fuel cell coupler and the fuel cell using it were described above, but the fuel cell socket of the embodiments, the fuel cell coupler and the fuel cell are not limited to the embodiments described above. It is to be understood that in a practical phase it can be materialized with the component elements modified without departing from the spirit and scope of the invention. And, various inventions can be made by an appropriate combination of the plural component elements described in the above embodiments.

For example, some component elements may be deleted from the whole component elements shown in the embodiments. For example, a passive type DMFC which is under downsizing is suitable as a fuel cell, but its method, mechanism or the like is not limited when it is provided with at least the fuel cell socket of the invention and the liquid fuel is supplied via the socket.

The fuel cell socket of the embodiments has the fuel introduction path having the fastener and the auxiliary elastic body which pushes the fastener toward the connection side. By configuring as described above, the fuel introduction path can be appropriately contacted to the fuel cell plug when the fuel cell plug is connected, and the liquid fuel is suppressed from leaking to the outside. Thus, excellent safety can be provided. The auxiliary elastic body is disposed outside of the fuel introduction path, so that the metal ions and the like eluted from the auxiliary elastic body can be suppressed from mixing into the liquid fuel. The above fuel cell socket can be used effectively for the fuel cell coupler and the fuel cell.

while certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuel cell socket, to which a fuel cell plug for discharging a liquid fuel for a fuel cell is detachably connected, comprising:
a cylindrical socket body having a diameter-reduced part provided at a substantially intermediate position in an axial direction;
a valve having a shaft portion which is protruded toward a connection side with the fuel cell plug through the diameter-reduced part;
an elastic cylindrical fuel introduction path, provided to surround the shaft portion protruded from the diameter-reduced part, having a fastener provided at a side portion; and
an auxiliary elastic body which is provided outside the fuel introduction path and pushes the fastener toward the connection side.

2. The fuel cell socket according to claim 1, wherein the fastener is an annular member having a retaining hole for retaining the fuel introduction path, and is attached to a side portion of the fuel introduction path.

3. The fuel cell socket according to claim 1, wherein the fastener is provided at end on the connection side of the fuel introduction path.

4. The fuel cell socket according to claim 1, wherein the fuel introduction path has sealing portions at its both ends, and the sealing portions have an axially protruded cross section.

5. The fuel cell socket according to claim 1, wherein the fuel introduction path is disposed to surround entirely of the shaft portion protruded from the diameter-reduced part.

6. The fuel cell socket according to claim 5, wherein the fuel introduction path is axially stretchable.

7. The fuel cell socket according to claim 6, wherein the fuel introduction path has a bellows shape.

8. The fuel cell socket according to claim 1, wherein the diameter-reduced part has an inner cylinder portion extended toward the connection side, and the fuel introduction path covers slidably a part on the connection side of the inner cylinder portion.

9. The fuel cell socket according to claim 8, wherein the fuel introduction path slides toward the diameter-reduced part to contact its end on the diameter-reduced part side to the diameter-reduced part.

10. A fuel cell coupler, comprising:
a fuel cell plug which discharges a liquid fuel for a fuel cell; and
the fuel cell socket according to claim 1 to which the fuel cell plug is detachably connected.

11. A fuel cell, comprising:
a membrane electrode assembly having a fuel electrode, an air electrode, and an electrolyte membrane sandwiched between the fuel electrode and the air electrode;
a fuel storing portion which stores a liquid fuel to be supplied to the fuel electrode of the membrane electrode assembly; and
the fuel cell socket according to claim 1 which is disposed on the fuel storing portion.
